(19) United States
(12) Patent Application Publication
(10) Pub. No.: US 2005/0265351 A1
(43) Pub. Date: Dec. 1, 2005

(54) Network administration

(75) Inventors: Richard James Smith, Bristol (GB); Jonathan Griffin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/141,760

(22) Filed: May 27, 2005

(30) Foreign Application Priority Data
May 27, 2004 (GB) 0411873.3
Oct. 12, 2004 (GB) 0422605.6

(51) Int. Cl. H04L 12/56; H04L 12/28

(52) U.S. Cl. 370/395.2; 370/401

(57) ABSTRACT

A method of managing access by a transient computing entity to a computing network via a virtual private network (‘VPN’) gateway, the method comprising the steps of: authenticating, at the VPN gateway, the identity of the transient entity and establishing a VPN connection between the gateway and the transient entity; restricting access of the transient entity to the network; performing a scanning operation on the transient entity to establish whether the transient entity has a known vulnerability; upon completion of the scanning operation, enabling access by the transient entity to at least a part of the network which, prior to performance of the scan, was restricted.

### BACKGROUND TO THE INVENTION

In a network environment virtually any processing entity (or “host”) is at one time or another connected to one or more other hosts. Thus, for example, a host in the form of a computer is frequently connected to one or more other computers, whether within an intranet of a commercial organisation, or as part of the internet. An inevitable result is that the opportunities for the propagation of “malicious” code, such as viruses or worms, which may cause deleterious effects to the network are enhanced.

Within the context of this specification malicious code is the data that is capable of being incorporated by a host and that may cause deleterious effect upon the performance of either the host itself, one or more other hosts, or a network of which any of the abovementioned hosts are a part. A characteristic effect of such code is that it propagates either through self-propagation or through human interaction. Thus for example, the code may act by becoming incorporated within a first host and subsequent to its incorporation may then cause deleterious effects within that first host, such as corruption and/or deletion of files (this type of code is normally known as a virus). In addition, the code may cause self-propagation to one or more further hosts at which it will then cause similar corruption/deletion and further self-propagation. Alternatively, the code may merely be incorporated within the first host and cause no deleterious effects whatsoever, until it is propagated to one or more further hosts where it may then cause such deleterious effects, for example, corruption and/or deletion of files. In yet a further alternative scenario, code may be incorporated within a first host and then cause itself to be propagated to multiple other hosts within the network. The code itself may have no deleterious effect upon any of the hosts by whom it is incorporated, but the self-propagation through the network per se may be of a sufficient magnitude to have a negative effect on the speed of “genuine” network traffic, so that the performance of the network is nonetheless effected in a deleterious manner (this type of code is normally known as a worm). The three examples given above are intended for the illustration of the breadth of the term code, and are not intended to be regarded in any way as exclusively definitive.

Worms and virus's infect computers by taking advantage of one or more vulnerabilities within the operating system or other software installed on a host computer. In this context, a vulnerability is any characteristic of a computer (whether hardware or software, and includes any impact of any surrounding context to that computer, such as network infrastructure) which is capable of being exploited to cause the computer to operate, at the behest of a third party, either contrary to the wishes of the computer's legitimate user or administrator, or without their knowledge. For example, some older operating systems incorporated software (unknown to many users) that automatically enabled the computing entity to operate as a web server, but which, due to a flaw in its operation, also left the entity vulnerable to attack by malicious code. Another example is the capability of a computing entity to establish a connection on port 22, which is indicative of the existence of a capability that runs on Linux operating systems known as secure shells (SSH), which has the capacity to provide a remote computing entity with administrative access to the user machine. Further examples of vulnerabilities are provided in UK patent application GB0409667.3, incorporated herein by reference.

Once a vulnerability of a computer to such viruses or worms becomes known rapid remedial action is typically taken by the installation of a “patch” that has the effect of removing the vulnerability. Such patches are typically made widely available to network administrators to install on a vulnerable host. One manner in which the potential vulnerability of a host within a network may be established is by downloading and running, on a user host, a script that checks that all of the appropriate patches are installed. The running of such a script can be initiated remotely by a network administrator or be caused to be initiated automatically in response to some triggering event.

UK patent application number GB0409667.3, also in the name of the current applicant and incorporated herein in its totality by reference, relates to the administration of a network of interconnected computers in which user computing entities are tested, or scanned, for the presence of known vulnerabilities in response to one or more trigger events. An example of a trigger event is the allocation of a network address to a user computing entity.

### SUMMARY OF THE INVENTION

The invention has been derived from an appreciation that whilst the periodic testing, or scanning, of network hosts is a reasonably efficient way of detecting vulnerabilities existing on hosts within a network, there nonetheless remains a clear window of opportunity for an infected or vulnerable machine to join and leave the network without being subject to a test or scan. These machines can be termed as being transient.

According to a first aspect of the present invention there is provided a method of man aging access by a transient computing entity to a computing network via a virtual private network (‘VPN’) gateway, the method comprising the steps of: authenticating, at the VPN gateway, the identity of the transient entity and establishing a VPN connection between the gateway and the transient entity; restricting access of the transient entity to the network; performing a scanning operation on the transient entity to establish whether the transient entity has a known vulnerability; upon completion of the scanning operation, enabling access by the transient entity to at least a part of the network which, prior to performance of the scan, was restricted.

### BRIEF DESCRIPTION OF THE DRAWINGS

FIG. 1 is a schematic illustration of a first embodiment of the present invention; and

FIG. 2 is a schematic illustration of a second embodiment of the present invention.

### DESCRIPTION OF PREFERRED EMBODIMENTS

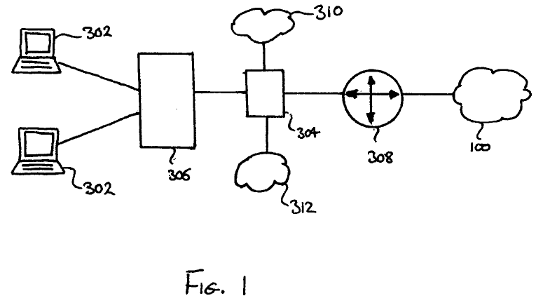

Referring to FIG. 1, an internal network (Intranet), such as a LAN, comprises a plurality of hosts, such as computing entities (not shown). The internal network is characterised by the fact that each of the computing entities are, in ordinary use, permanently connected to the network. An example of such an internal network would be the physical computer network within a single building of a company.

Also illustrated in FIG. 1 are a plurality of transient computing entities 302 that in use may be used to temporarily establish a connection with the internal network 100. There can be a number of reasons for a computing entity to appear as transient, the most common of which is that they only have temporary access to the internal network 100. This access is most commonly established through a VPN (virtual private network) or wirelessly. In secure networks, such as company intranets, it is often the case that a wireless network is treated as untrusted and so connects to the LAN via a VPN anyway. A virtual private network is a network of interconnected computing entities that uses an existing public network to establish the interconnections, but uses an additional level of security, such as encryption of the transmissions, to ensure only computing entities within the virtual private network and not other entities on the public network have access to communications sent via the virtual private network. An example of a virtual private network would be the connection of an individuals home computer to a company LAN via the internet.

The transient computing entities 302 are typically home computers or laptop/PDAs and as such are at a higher risk of being either infected or vulnerable to infection than a centrally managed desktop computer within a companies premises. There is therefore a need to be able to ensure a level of security compliance of such transient machines at the time that they attempt connection to the internal network 100, as opposed to hoping that they are included in a periodic security scan whilst connected to the internal network.

In the embodiment of the present invention illustrated in FIG. 1, a security scanner 304 is connected to a VPN gateway 306 to which the transient computing entities 302 temporarily connect. Also connected to the security scanner 304 is a network router 308 that is in turn connected to the internal network 100. It will be appreciated that the VPN gateway 306, security scanner 304 and network router 308 may all be located at the premises of the internal network 100 operator, although this is not necessarily the case always. It will also be appreciated that although illustrated as discrete units, the VPN gateway, security scanner and router may be implemented by software applications running on one or more computing entities within the internal network 100. Typically the VPN gateway and scanner may be hosted on a single hardware entity. In the illustrated embodiment, the gateway 304 has been illustrated as being topographically, and therefore in software terms where both scanner and gateway entities are hosted on a single hardware entity, logically proximal to the external, transient entities. It is equally possible to configure the system the other way around.

The function of the VPN gateway 306 is to encrypt outgoing packets of data directed to the transient computing entities 302 so as to create the virtual private network over the public network by which communications between the transient computing entities 302 and the VPN gateway are accomplished. The VPN gateway 306 also carries out the required decryption on packets received from the transient computing entities 302. The operation of the VPN gateway 306 may be in accordance with known techniques. The function of the router 308 is to direct packets of a data to the appropriate computing entities within the internal network 100 in accordance with the IP addresses specified in the data packets.

A further function of the VPN gateway 306 is to authenticate a transient computing entity 302 that is attempting to establish communication as being permitted to do so. Authentication is typically performed by one of a number of standard Challenge-Reponse interactions. For example, the VPN gateway 306 may authenticate on the basis of a dynamically generated password at the transient computing entity, and transmitted using the VPN client operating at that entity. Alternative methods are equally possible, such as the use of smartcards or bio information sensors has been provided by the transient computing entity 302. In the present embodiment of the invention, successful completion of the authentication and assignment to the transient computing entity 302 of an IP Address does not permit the access to the network sought by the transient entity. Before this is permitted, the security scanner 304 performs a scanning operation on the transient entity to establish whether the transient computing entity 302 has one or more known vulnerabilities. Scanning may be performed, for example, by attempting to communicate with the transient computing entity 302 using a specified application level protocol, the presence of which is either directly or deductively indicative of the presence of a vulnerability within the transient computing entity 302. Other kinds of scanning operation may also be conducted, for example attempting to establish a connection with the transient computing entity 302 and recording the time intervals that lapse between the various data packets sent back from the computing entity 302 that are required in accordance with the protocol employed, to establish a connection. The magnitude of these time intervals can, in certain circumstances, reveal the operating system employed by the transient computing entity 302, and this information can, in turn, enable deductive or diagnosis of the presence, or likely presence, of various vulnerabilities. Other scanning methodologies as known to persons skilled in the art may also be applied.

Because authentication does not provide general, unimpeded network access to the transient entity until scanning has been completed, while the security scanner 304 is checking the transient computing entity 302 for vulnerabilities or infections, in the present embodiment any further data packets received from the transient computing entity via the VPN gateway 306 are routed to a first additional network 310. Typically this will be performed by a computing entity which is administering the VPN, but this is not necessarily the case and the scanning entity may either perform this function or instruct the router to do so. In this restricted access mode, any data packets received from the transient computing entity 302 are directed solely to this first additional network and are not allowed to be passed to the internal network 100. Thus, in the restricted access mode, where data packets are routed to the first additional network 310, the transient computing entity 302 can be considered to have been placed in a quarantine. The extent of any restricted access or quarantine is typically determined by network administration policy, and is likely to vary from one network to another. Thus, in one embodiment, quarantine may merely be a restriction preventing a transient entity contacting certain specified addresses, or restricting the use of certain protocols (typically by preventing transmission of packets on certain logical port numbers). Alternatively, and at the other end of the policy spectrum, quarantine may allow only sufficient network access via the VPN such as to enable the scanning operation to take place. In the present embodiment, whilst in quarantine, transient computing entities 302 are unable to communicate with any other computing entities on the internal network 100. Depending upon policies applied by the network administrators to the first additional network 310, transient computing entities 302 in quarantine may also not be able to communicate with one another.

If on completion of the security scanning procedures it is determined that the transient computing entity 302 does not have any vulnerabilities or infections, data packets received from the computing entity 302 are routed via the router 308 to the internal network 100, allowing the transient computing entity 302 to communicate with any other machines within the internal network 100 and to have full access to these services provided by the internal network 100.

If on the other hand the scanning procedures determine that the transient computing entity 302 does have a vulnerability or an infection, data packets are routed by the security scanner 304 to a second additional network 312. As with the first additional network 310, a transient computing entity 302 connected to the second additional network 312 cannot communicate with any of the computing entities within the internal network 100, and cannot communicate with any other transient computing entities 302 connected to the second additional network 312. Again, depending on policies applied to the second additional network 312, transient computing entities connected to the second additional network may have access to information services explaining why they have been denied access to the internal network 100, or providing remedial information to remove the detected vulnerability or infection. Transient computing entities connected to the second additional network 312 may additionally have access to a limited network service, such as access to web mail. The security scanner 304 may, on detection of a vulnerability, also take action by utilising the detected vulnerability, for example by causing a pop-up window to appear on the display screen of the transient computing entity 302, the pop-up window including information warning the user that a vulnerability exists.

It will be noted that in the embodiment shown in FIG. 1 the security scanner 304 is located in between the VPN gateway 306 and the network router 308. This is to ensure that all data packets authenticated by the VPN gateway must pass through the security scanner 304 to access the internal network 100, as well as all network traffic trying to reach the transient computing entities 302. As a result, the security scanner 304 is capable of diverting data packets received from the transient computing entities 302 between the different networks, i.e. the internal network 100 and first and second additional networks 310 and 312, depending on their vulnerability assessment. There are no other routes available for data packets to take to bypass the security scanner 304. Once a transient computing entity 302 has passed the vulnerability assessment employed by the security scanner, the security scanner 304 is effectively transparent, as it allows network traffic to flow freely in both directions between the transient computing entity 302 and the internal network 100. If the transient computing entity 302 is in the process of being scanned by the security scanner 304, or has failed the vulnerability assessment applied by the security scanner, then, in accordance with one embodiment of network administration policy, the security scanner operates to drop all data packets from the internal network 100 directed to the transient computing entity. Traffic from the transient computing entity destined for the internal network 100 can be selectively dropped, depending upon the policies of protocols employed, or diverted into the appropriate additional network 310 or 312.

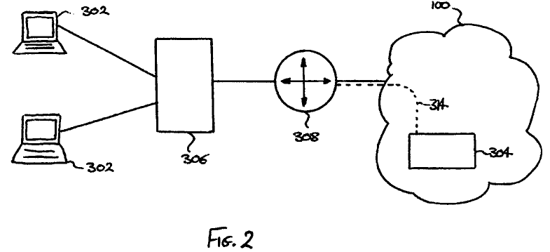

An alternative embodiment of the present invention is illustrated as in FIG. 2. In the alternative embodiment the security scanner 304 is located within the internal network 100, with the internal network being connected to the VPN gateway 306 by the router 308. The operation of the router 308 is controlled by the security scanner 304, as indicated by the chained line 314. In this way data packets from transient computing entities 302 that are attempting to establish a new connection to the internal network 100 are detected by the security scanner 304 as described previously with reference to FIG. 1, and the same security scanning procedures can be performed. The direction of data packets to and from the transient computing entities 302 is controlled by the router 308 under the control of the security scanner 304. In this manner the security scanner 304 may also provide security scanning functions for the permanent computing entities located within the internal network 100.

It will be appreciated by those skilled in the art that the first and second additional networks 310 and 312 described above with reference to FIG. 1 need not be physically separate entities, but may utilise computing services residing within the internal network 100. However, the operation of the router 308 prevents data packets that have been determined to be sent to either of the additional networks from being sent to any computing entities within the internal network 100. This may be achieved using conventional network routing techniques, such as IP addresses.

1. A method of managing access by a transient computing entity to a computing network via a virtual private network (‘VPN’) gateway, the method comprising the steps of:
authenticating, at the VPN gateway, the identity of the transient entity and establishing a VPN connection between the gateway and the transient entity;
restricting access of the transient entity to the network;
performing a scanning operation on the transient entity to establish whether the transient entity has a known vulnerability;
upon completion of the scanning operation, enabling access by the transient entity to at least a part of the network which, prior to performance of the scan, was restricted.

2. A method according to claim 1, wherein once the scanning operation the method comprises a further step, prior to enabling access, of remediating a detected vulnerability.

3. A method according to claim 2, wherein access is enabled after a scanning operation without a remediation step if no vulnerabilities are detected.

4. A method according to claim 1 wherein, while restricting access mode, the transient computer is able to receive selected data packets.

5. A method according to claim 2, wherein, upon completion of a scanning operation the transient computing entity is permitted access to a selected subset of network entities.

6. A method according to claim 4 wherein, subsequent to detection of vulnerabilities and before remediation of a vulnerabilities in the transient entity is complete, traffic from the transient entity is restricted on the basis of port number.

7. An intranetwork having:
a gateway computing entity providing a virtual private network (‘VPN’) gateway adapted to authenticate a transient computing entity located outside the intranet and, subsequent to the authentication, maintain a VPN connection with a VPN client entity on the transient entity;
a scanning computing entity adapted to probe the authenticated transient entity, via the VPN connection, for vulnerabilities in the transient entity, and to restrict access by the transient entity to the intranet pending satisfactory completion of scan.

8. An intranet according to claim 7 wherein the scanning entity is adapted to instruct the gateway to restrict access.

9. An intranet according to claim 8 wherein the scanning entity is adapted to enable the transient entity, upon completing authentication but prior to completion of a scan, to receive data on specified ports.

10. An intranet according to claim 9 wherein the scanning entity is adapted to instruct another computing entity within the intranet to enable transmission of packets to the transient entity on specified ports.
